(19) United States
(12) Patent Application Publication
(10) Pub. No.: US 2025/0297053 A1
(43) Pub. Date: Sep. 25, 2025

(54) Thermoplastic Polyurethane and Uses Thereof

(71) Applicant: Huntsman International LLC, The Woodlands, TX (US)

(72) Inventors: Lan Cao, Derry, NH (US); Giacomo Giannini, Tienen (BE); Hugo Verbeke, Tienen (BE)

(21) Appl. No.: 18/863,384

(22) PCT Filed: May 4, 2023
(86) PCT No.: PCT/US2023/020983

§ 371 Date: Nov. 6, 2024

Related U.S. Application Data
(60) Provisional application No. 63/341,613, filed on May 13, 2022.

(51) Int. Cl. C08G 18/75; B32B 17/10; C08G 18/32; C08G 18/42; C08G 18/48; C08G 18/66; C08J 5/18

(52) U.S. Cl. CPC C08G 18/755; B32B 17/10018; B32B 17/10036; B32B 17/1077; C08G 18/3206; C08G 18/4277; C08G 18/4854; C08G 18/664; C08G 18/6674; C08J 5/18; B32B 2274/00; B32B 2457/00; B32B 2605/00; C08J 2375/06; C08J 2375/08

(57) ABSTRACT

The present disclosure provides a thermoplastic polyurethane obtained from the reaction of a reaction mixture comprising (i) a polyisocyanate comprising isophorone diisocyanate, (ii) a polyol component comprising an aliphatic polyester polyol or an aliphatic polyether polyol, and (iii) a chain extender. The thermoplastic polyurethane may be used in a variety of applications, such as in automotive, electronic device and consumer product applications.

### CROSS REFERENCE TO RELATED APPLICATIONS

This application claims the benefit of U.S. Provisional patent application Ser. No. 63/341,613, filed May 13, 2022, the entire contents of which are expressly incorporated herein by reference.

### STATEMENT REGARDING FEDERALLY SPONSORED RESEARCH OR DEVELOPMENT

Not applicable.

### FIELD

The present disclosure relates to transparent, low-yellowing thermoplastic polyurethanes having good elasticity and processability, and the preparation and use thereof.

### BACKGROUND

Thermoplastic polyurethanes (TPUs) are currently being used in manufacturing a wide variety of products for many applications by various melt processing techniques, such as injection molding and extrusion. For instance, TPUs are commonly used in making seals, gaskets, catheters, wires, and cables and for surface protection of various articles, such as automotive parts and electronic devices. Such TPUs are typically made by reacting (1) a hydroxyl terminated polyether or hydroxyl terminated polyester, (2) a chain extender, and (3) an isocyanate compound. These TPUs are segmented polymers having soft segments and hard segments which accounts for their excellent elastic properties. The soft segments are derived from the isocyanate and hydroxyl terminated polyether or polyester and the hard segments are derived from the isocyanate and the chain extender. The chain extender is typically one of a variety of glycols, such as 1,4-butanediol.

With respect to light-stable, transparent TPU films, isocyanate compounds, in particular, hydrogenated methylene diphenyl diisocyanate (H₁₂-MDI) is mostly used. However, in recent years, the demand for H₁₂-MDI has increased significantly due to the growing demand in the automotive and consumer electronics markets for light-stable, transparent TPU film which has outpaced the supply and has resulted in a global material shortage. Therefore, it would be desirable to identify an alternative isocyanate compound that can be used in the place of H₁₂-MDI without sacrificing the TPU film's performance properties.

### SUMMARY

The present disclosure describes a thermoplastic polyurethane obtained from the reaction of a reaction mixture comprising: (i) a polyisocyanate comprising isophorone diisocyanate; (ii) a polyol component comprising an aliphatic polyester polyol or an aliphatic polyether polyol; and (iii) a chain extender.

The present invention further discloses a method of making the thermoplastic polyurethane comprising reacting a reaction mixture of (i) a polyisocyanate comprising isophorone diisocyanate, (ii) a polyol component comprising an aliphatic polyester polyol or an aliphatic polyether polyol, and (3) a chain extender. The thermoplastic polyurethane may be prepared by any known or hereafter developed method for making thermoplastic polyurethanes.

The present disclosure further provides an article which comprises the described thermoplastic polyurethane.

In one embodiment the article comprises a film useful in protecting surfaces, such as an airfoil, or for bonding surfaces, such as glass to glass or glass to polymer. In another embodiment, the article comprises an automotive part. In another embodiment, the article comprises part of an electronic device, such as a casing for a mobile phone. In other embodiment, the article is a watch band or wearable device. In still another embodiment, the article is an eyeglass frame.

### DETAILED DESCRIPTION

The present disclosure generally provides a thermoplastic polyurethane obtained from the reaction of a reaction mixture comprising: (i) a polyisocyanate comprising isophorone diisocyanate; (ii) a polyol component comprising an aliphatic polyester polyol or an aliphatic polyether polyol; (iii) a chain extender; and optionally (iv) one or more additives. The thermoplastic polyurethanes of the present disclosure exhibit a well balance of properties such as a high transparency, good elasticity and little to no yellowing. Such well-balanced properties are at least similar to, if not better than, those for thermoplastic polyurethanes obtained from reaction mixtures containing hydrogenated methylene diphenyl diisocyanate. Accordingly, the thermoplastic polyurethanes are suitable for use in a variety of applications, such as in automotives applications, (e.g., interior and exterior parts including, but not limited to, dashboard consoles, shifter handles, radio controls, headlamps, roof components, paint protection films), electronic devices (e.g., mobile phone casings), consumer products (e.g., eyeglass frames, watch bands, wearable devices), surface protection applications (e.g., films for wind turbine blades, films for leading edge substrate on an airfoil, such as aircraft wings, rotor blades and propeller blades), and in architectural, military, security, and aerospace applications as part of a laminated glazing.

If appearing herein, the term “comprising” and derivatives thereof are not intended to exclude the presence of any additional component, step, or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step, or procedure, except those that are not essential to operability and the term “consisting of”, if used, excludes any component, step or procedure not specifically delineated or listed. The terms “or” and “and/or”, unless stated otherwise, refer to the listed members individually as well as in any combination. For example, the expressions A or B and A and/or B refer to A alone, B alone, or to both A and B.

The articles “a” and “an” are used herein to refer to one or to more than one (i.e., to at least one) of the grammatical objects of the article. By way of example, “a polyisocyanate” means one polyisocyanate or more than one polyisocyanate. The phrases “in one embodiment”, “according to one embodiment” and the like generally mean the feature, structure, or characteristic following the phrase is included in at least one embodiment of the present disclosure and may be included in more than one embodiment of the present disclosure. Importantly, such phrases do not necessarily refer to the same embodiment. If the specification states a component or feature “may”, “can”, “could”, or “might” be included or have a characteristic, that component or feature is not required to be included or have the characteristic.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the present disclosure.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “optional” or “optionally” means that the subsequently described event or circumstance may or may not occur, and that the description includes instances where said event or circumstance occurs and instances where it does not.

“Isocyanate index” or “NCO index” or “index” refers to the ratio of NCO-groups over isocyanate-reactive hydrogen atoms present in a formulation, given as a percentage: [NCO]×100/[active hydrogen] (%).

The term “hydroxyl value” refers to the concentration of hydroxyl groups, per unit weight of the polyol, that can react with the isocyanate groups. The hydroxyl number is reported as mg KOH/g and may be measured according to the standard ASTM D 1638.

The term “average functionality”, or “average hydroxyl functionality” of a polyol indicates the number of OH groups per molecule, on average. The average functionality of an isocyanate refers to the number of —NCO groups per molecule, on average.

The term “substantially free” refers to a composition in which a particular constituent or moiety is present in an amount that has no material effect on the overall composition. In some embodiments, “substantially free” may refer to a composition in which the particular constituent or moiety is present in the composition in an amount of less than about 5 wt. %, or less than about 4 wt. %, or less than about 3 wt. % or less than about 2 wt. % or less than about 1 wt. %, or less than about 0.5 wt. %, or less than about 0.1 wt. %, or less than about 0.05 wt. %, or even less than about 0.01 wt. % based on the total weight of the composition, or that no amount of that particular constituent or moiety is present in the respective composition.

According to one embodiment, the present disclosure provides a thermoplastic polyurethane obtained from the reaction of a reaction mixture comprising: (i) a polyisocyanate comprising an isophorone diisocyanate, (ii) a polyol component comprising an aliphatic polyester polyol or an aliphatic polyether polyol, and (iii) a chain extender. The technique under which these reactants are polymerized to synthesize the thermoplastic polyurethane may be conducted utilizing conventional processing equipment, catalysts, and processes. However, the polymerization is conducted in a manner that will result in the desired characteristics or properties of the thermoplastic polyurethane. The types and levels of polyisocyanate, aliphatic polyols and chain extender, or a combination thereof can be adjusted to attain the desired set of chemical and physical characteristics for the polyurethane being synthesized. The polymerization techniques useful in making the thermoplastic polyurethanes of this disclosure include conventional methods, such as reactive extrusion, batch processing, solution polymerization, and cast polymerization.

In one embodiment, the polyisocyanate used in synthesizing the thermoplastic polyurethane is an aliphatic polyisocyanate, in particular an aliphatic diisocyanate. In some embodiments, the polyisocyanate in the present disclosure is substantially free of aromatic diisocyanates.

In one embodiment, the aliphatic diisocyanate is isophorone diisocyanate. In addition to isophorone diisocyanate, the polyisocyanate may further comprise an aliphatic diisocyanate having a structure:

O═C═N—R—N═C═O

where R is chosen from substituted or unsubstituted (C₁-C₄₀)alkylene, (C₂-C₄₀)alkenylene, and (C₄-C₂₀) cycloalkylene. In some embodiments, the diisocyanate is chosen from hydrogenated methylene diphenyl diisocyanate, cyclohexylene diisocyanate, methyl cyclohexylene diisocyanate, bis(2-isocyanato-ethyl)-4-cyclohexene-1,2-dicarboxylate, or 2,5- or 2,6-norbornane diisocyanate, ethylene diisocyanate, tetramethylene diisocyanate, hexamethylene diisocyanate, dodecamethylene diisocyanate, 1,6,11-undecane triisocyanate, 2,2,4-trimethyl hexamethylene diisocyanate, lysine diisocyanate, 2,6-diisocyanato-methyl caproate, bis(2-isocyanato-ethyl) fumarate, bis(2-isocyanato-ethyl) carbonate, 2-isocyanato-ethyl-2,6-diisocyanato-hexanoate or mixtures thereof. Dimers and trimers of the above diisocyanates may also be used. In one embodiment, the polyisocyanate is substantially free of any aliphatic diisocyanate other than isophorone diisocyanate.

The polyisocyanate may range from about 0.5 wt. % to about 50 wt. % of the total weight of the reaction mixture, or from about 10 wt. % to about 45 wt. %, or from about 25 wt. % to about 42 wt. %, or less than, equal to, or greater than about 0.5 wt. %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5 or 48 wt. % of the total weight of the reaction mixture. The amount of the polyisocyanate in the reactive mixture can also be expressed in terms of an isocyanate index. According to various embodiments, the isocyanate index of the reactive mixture is in a range of from about 0.95 to about 1.20, or from about 0.97 to about 1.05, or less than equal to, or greater than about 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, or 1.20.

In one embodiment, the polyol component comprises an aliphatic polyester polyol for synthesizing the thermoplastic polyurethane. The aliphatic polyester polyol can include any suitable number of hydroxyl groups. For example, the polyester polyol can include four hydroxyl groups or three hydroxyl groups. The polyester polyol can even include two hydroxyl groups such that the polyester polyol is a polyester diol. In general, the aliphatic polyester polyol can be a product of a condensation reaction, such as a polycondensation reaction, or it can be made via a ring opening polymerization of a cyclic ester compound such as ε-caprolactone, or γ-butyrolactone.

In embodiments where the polyester polyol is made according to a condensation reaction, the reaction can be between one or more aliphatic carboxylic acids and one or more polyols. Examples of aliphatic carboxylic acids include: adipic acid, sebacic acid, azelaic acid and decamethylene dicarboxylic acid. A single type of these acids may be used or a combination of two or more types may also be used. Examples of polyols include 1,6-hexanediol, ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentanediol, 1,5-hexanediol, 2,5-hexanediol, 1,6-hexanediol, 1,7-heptanediol, 1,8-octanediol, 1,9-nonanediol, 1,10-decanediol, neopentyl glycol, 3-methyl-1,5-pentanediol, and 2-methyl-1,3-propanediol. Particular examples of aliphatic polyester polyols include poly(hexamethylene adipate) (PHMA) and poly(butylene adipate)(PBA).

In another embodiment, the aliphatic polyester polyol is a polylactone polyol which may be di- or tri- or tetra hydroxyl in nature. Such polyols are prepared by the reaction of a lactone monomer; illustrative of which is γ-butyrolactone, ε-caprolactone, γ-methyl-ε-caprolactone, and ζ-enantholactone, which is reacted with an initiator that has at least two reactive hydrogens.

In one embodiment, the aliphatic polyester polyol is a polycaprolactone polyol. The polycaprolactone polyol may be produced by the catalytic polymerization of an excess of ε-caprolactone and an initiator containing at least two reactive hydrogens. Initiators include diols such as ethylene glycol, diethylene glycol, triethylene glycol, 1,2-propylene glycol, dipropylene glycol, 1,3-propylene glycol, polyethylene glycol, polypropylene glycol, poly(oxyethylene-oxypropylene-glycols, and similar polyalkylene glycols, either blocked, capped or heteric, containing up to about 40 or more alkyleneoxy units in the molecule, 3-methyl-1-5-pentanediol, cyclohexanediol, 4,4′-methylene-bis-cyclohexanol, 4,4′-isopropylidene biscyclohexanol, xylenediol, 2-(4-hydroxymethylphenyl) ethanol, 1,4-butanediol, and the like; triols such as glycerol, trimethylolpropane, 1,2,6-hexanetriol, triethanolamine, triisopropanolamine, and the like; and tetrols such aserythritol, pentaerythritol, N,N,N′,N′-tetrakis-(2-hydroxyethyl)ethylene diamine, and the like. In some embodiments, the polycaprolactone polyol may have an average molecular weight of from about 290 Da to about 6000 Da, or from about 500 Da to about 4000 Da or from about 1000 Da to about 3000 Da.

According to one embodiment, the polyol component comprises an aliphatic polyether diol. Polyether diols can be produced by known processes, for example via anionic polymerization of alkylene oxides with alkali metal hydroxides, such as sodium hydroxide or potassium hydroxide, or with alkali metal alcoholates, such as sodium methoxide, sodium ethoxide, or potassium ethoxide, or potassium isopropoxide, as catalysts, and with addition of at least one starter molecule which comprises from 2 to 3, preferably 2, reactive hydrogen atoms in bonded form, or via cationic polymerization with Lewis acids as catalysts from one or more alkylene oxides having from 2 to 4 carbon atoms in the alkylene moiety. Examples of suitable alkylene oxides are tetrahydrofuran, propylene 1,3-oxide, ethylene oxide and propylene 1,2-oxide. The alkylene oxides can be used individually, in alternating succession, or in the form of mixtures. Examples of starter molecules that can be used are water, organic dicarboxylic acids, such as succinic acid and adipic acid, and preferably dihydric alcohols optionally comprising ether bridges in bonded form, e.g., ethanediol, 1,2-propanediol, 1,4-butanediol, diethylene glycol, 1,6-hexanediol, and 2-methyl-1,5-pentanediol. The starter molecules can be used individually or in the form of mixtures. The polytetrahydrofurans (polyTHFs) comprising hydroxy groups are suitable and preferred.

The polyTHF may be synthesized by the polymerization of tetrahydrofuran. One or more types of polyTHF can be reacted to form the thermoplastic polyurethane. PolyTHF, also known in the art as poly(tetramethylene ether)glycol or poly(tetramethylene oxide), in some embodiments, has the following general structure:

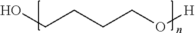

where n is an integer of from about 1 to about 100, alternatively from about 5 to about 75, alternatively from about 5 to about 50, alternatively from about 5 to about 20. Alternatively, in such embodiments, polyTHF can have a weight average molecular weight of from about 650 Da to about 3000 Da, alternatively from about 1000 Da to about 2750 Da, alternatively from about 625 to about 1675, alternatively from about 950 to about 1050, alternatively from about 1750 to about 1850, alternatively from about 1950 to about 2050, or alternatively from about 2800 to about 3000, g/mol. In some embodiments, polyTHF can have a hydroxyl number from about 30-1000 mg KOH/g, alternatively from about 500-540 mg KOH/g, alternatively from about 410-500 mg KOH/g, alternatively from about 165-180 mg KOH/g, alternatively from about 110 to about 120 mg KOH/g, alternatively from about 60-65 mg KOH/g, alternatively from about 55-58, mg KOH/g alternatively from about 35-40 mg KOH/g.

In another embodiment, the polyol component may further comprise a polycarbonate polyol, such as a hydroxyl terminated polycarbonate including those prepared by reacting a glycol with a carbonate. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40 carbon atoms, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5- to 7-member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkyl carbonates and cycloaliphatic carbonates. The dialkylcarbonates can contain 2 to 5 carbon atoms in each alkyl group and specific examples thereof are diethyl carbonate and dipropylcarbonate. Cycloaliphatic carbonates, especially dicycloaliphatic carbonates, can contain 4 to 7 carbon atoms in each cyclic structure. The various polycarbonate intermediates generally have a number average molecular weight as determined by assay of the terminal functional groups which is an average molecular weight greater than about 700 Da, such as from about 700 Da to about 10,000 Da, from about 1,000 Da to about 5,000 Da, or from about 1,000 Da to about 2,500 Da.

In some embodiments, the polyol component may include a mixture of polyols. For example, in one embodiment, the polyol component may comprise a mixture of a polylactone polyol and an aliphatic polyether diol. In other embodiments, the polyol component may consist essentially of a polylactone polyol. In another embodiment, the polyol component may consist of a polylactone polyol. In still other embodiments, the polyol component may consist essentially of an aliphatic polyether diol. In some embodiments, the polyol component may consist of an aliphatic polyether diol. In other embodiments, the polyol component may be substantially free of polycarbonate polyols.

In one embodiment, the polyol component may range from about 30 wt. % to about 70 wt. % of the total weight of the reaction mixture, or from about 35 wt. % to about 65 wt. %, or from about 40 wt. % to about 60 wt. %, or less than, equal to, or greater than about 30 wt. %, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, or 68 wt. % of the total weight of the reaction mixture.

The thermoplastic polyurethane is also made using a chain extender. Such chain extenders include diols, triols, diamines, and combinations thereof. In some embodiments, the chain extender may have a molecular weight of up to about 500 Da or up to about 300 Da, such as at least about 35-500 Da.

One or more short chain polyols having from 2 to 20, or 2 to 12, or 2 to 10 or 2 to 8 carbon atoms may be used as chain extenders in the reaction mixture to increase the molecular weight of the thermoplastic polyurethane. Examples of chain extenders include, but are not limited to, lower aliphatic polyols and short chain aromatic glycols having molecular weights of less than 500 Daltons or less than 300 Daltons. Suitable chain extenders include organic diols (including glycols) having a total of from 2 to about 20 carbon atoms such as alkane diols, cycloaliphatic diols, alkylaryl diols, and the like. Exemplary alkane diols include ethylene glycol, diethylene glycol, 1,3-propanediol, 1,3-butanediol, 1,4-butanediol, (BDO), 1,5-pentanediol, 2,2-dimethyl-1,3-propanediol, propylene glycol, dipropylene glycol, 1,6-hexanediol, 1,7-heptanediol, 1,9-nonanediol, 1,10-decanediol, 1,12-dodecanediol, tripropylene glycol, triethylene glycol, and 3-methyl-1,5-pentanediol. Examples of suitable cycloaliphatic diols include 1,2-cyclopentanediol, and 1,4-cyclohexanedimethanol (CHDM). Examples of suitable aryl and alkylaryl diols include hydroquinone di(1,3-hydroxyethyl) ether (HQEE), 1,2-dihydroxybenzene, 1,3-dihydroxybenzene, 1,4-dihydroxybenzene, 1,2,3-trihydroxybenzene, 1,2-di(hydroxymethyl)benzene, 1,4-di(hydroxymethyl)benzene, 1,3-di(2-hydroxyethyl)benzene, 1,2-di(2-hydroxyethoxy)benzene, 1,4di-(2-hydroxyethoxy)benzene, bisethoxy biphenol, 2,2-di(4-hydroxyphenyl) propane (i.e., bisphenol A), bisphenol A ethoxylates, bisphenol F ethoxylates, 4,4-isopropylidenediphenol, 2,2-di [4-(2-hydroxyethoxy)phenyl]propane (HEPP), and mixtures thereof.

Examples of triols include, but are not limited to, glycerol, trimethylolmethane, trimethylolethane, trimethylolpropane, 1,2,4-butanetriol, pentaerythritol, digylcerol, triglycerol, and higher condensation products of glycerol, di(trimethylolpropane), di(pentaerythritol), trihydroxymethyl isocyanurate, tris(hydroxyethyl) isocyanurate (THEIC), tris(hydroxypropyl) isocyanurate, inositols, sugars, e.g. glucose, fructose, or sucrose, sugar alcohols, e.g. sorbitol, mannitol, threitol, erythritol, adonitol (ribitol), arabitol (lyxitol), xylitol, dulcitol (galactitol), maltitol, isomalt, and trifunctional or higher-functionality polyetherols based on trifunctional or higher-functionality alcohols and propylene oxide and/or butylene oxide.

In one embodiment, the chain extender comprises an aliphatic glycol having from 2 to 20 carbon atoms, or 2 to 12 carbon atoms, or 2 to 10 carbon atoms or mixtures thereof. In another embodiment, the chain extender of the present consists essentially of or consists of an aliphatic glycol having from 2 to 20 carbon atoms, or 2 to 12 carbon atoms, or 2 to 10 carbon atoms or mixtures thereof.

In one embodiment, the chain extender may range from about 0.5 wt. % to about 25 wt. % of the total weight of the reaction mixture, or from about 2 wt. % to about 20 wt. %, or from about 5 wt. % to about 15 wt. %, or less than, equal to, or greater than about 1 wt. %, 2, 3, 4, 5, 6, 7, 8, 9, 10, 11, 12, 13, 14, 15, 16, 17, 18, 19, or 20 wt. % of the total weight of the reaction mixture.

Optionally, it may be desirable to utilize one or more additives. In one embodiment the additive may include a catalyst, such as metal carboxylates as well as tertiary amines. Examples of metal carboxylate catalysts include stannous octoate, dibutyltin dilaurate, phenyl mercuric propionate, lead octoate, iron acetylacetonate, magnesium acetyl acetonate, bismuth neodecanoate, and the like. Examples of tertiary amine catalysts include triethyleneimine, triethylenediamine and imidazoles, for example dimethylimidazole. Other catalysts like maleate esters and acetate esters and the like may also be used. The amount of the one or more catalysts is low, generally from about 50-100 parts by weight per million parts by weight of the end thermoplastic polyurethane polymer formed.

According to another embodiment, there is provided a method for producing the thermoplastic polyurethane by reacting the polyol component, the polyisocyanate and the chain extender of the reaction system. The various reactants of the reaction mixture can be combined in any order, although it is preferred to add the polyisocyanate last or simultaneously with the other reactants.

Additionally, the thermoplastic polyurethanes of the disclosure can be mixed with various conventional additives or compounding agents, such as antioxidants, non-ionic surfactants, silicon-based surfactants, waxes, colorants, biocides, fungicides, antimicrobial agents, anti-static additives, plasticizers, fillers, extenders, flame retardants, impact modifiers, pigments, lubricants, mold release agents, rheology modifiers, UV absorbers, and the like. The level of such conventional additives will depend on the final properties and cost of the desired end-use application, as is well known to those skilled in the art of compounding thermoplastic polyurethanes. These additional additives can be incorporated into the polyisocyanate, the polyol component or the chain extender of the reaction mixture, or directly into the reaction mixture for the preparation of the thermoplastic polyurethane, or they may be incorporated after the thermoplastic polyurethane has been made. In another method, all of the additives can be mixed with the thermoplastic polyurethane and then melted or they can be incorporated directly into the melt of the thermoplastic polyurethane.

The resulting thermoplastic polyurethane is a material with hard segment ratios of at least about 10%. In other embodiments, the hard segment ratio is at least about 20%, or at least about 25%, or at least 30%, or at least about 35%, or at least about 40%, or at least about 45%, or at least about 50%. In other embodiments, the hard segment ratios may be up to about 20%, or up to about 25%, or up to about 30%, or up to about 35%, or up to about 40%, or up to about 45%, or up to about 50%, or up to about 60%. In certain embodiments, the hard segment ratio is between about 40% and about 50%. The hard segment refers to the portion of the polyurethane formed between the chain extender and the polyisocyanate and can be estimated by calculation of the ratio of weight of polyisocyanate and chain extender to the weight of the thermoplastic polyurethane.

In some embodiments, the weight average molecular weight of the thermoplastic polyurethane of the present disclosure may range from about 50,000 Da to about 250,000 Da in one aspect, and from about 100,000 Da to about 200,000 Da in another aspect. The weight average molecular weight may be measured according to gel permeation chromatography (GPC) against a polystyrene standard.

According to another embodiment, the thermoplastic polyurethane may have an ASTM D-1003 haze value of less than about 10%, or less than about 9.5%, or less than about 9%, or less than about 8.5%, or less than about 8%, or less than about 7.5%, or less than about 7%, or less than about 6.5%, or less than about 6%, or less than about 5.5%, or less than about 5%, or less than about 4.5% or less than about 4%.

According to still another embodiment, the thermoplastic polyurethane may have an ASTM E313 yellowness index of less than 1%. All individual values and subranges of a yellowness index of less than 1% are included herein and disclosed herein; for example, the yellowness index can be from an upper limit of 1%, 0.9%, 0.8%, 0.7%, 0.6% or 0.5%. In one embodiment, the yellowness index of the film has a lower limit of 0.1%.

In still another embodiment, the thermoplastic polyurethane may have an elongation at break of at least about 365%, or at least about 370%, or at least about 380%, or at least about 390% or at least about 400% according to ASTM D412.

In yet another embodiment, the thermoplastic polyurethane may have a tensile strength of at least about 65 MPa, or at least about 66 MPa, or at least about 68 MPa, or least about 70 MPa, or at least about 72 MPa, or at least about 75 MPa according to ASTM D412.

The thermoplastic polyurethane may be shaped into desirable end use articles by any suitable means known in the art, such as any thermoforming or extrusion process. In one embodiment, the article is shaped by thermoforming. Thermoforming is a process of forming at least one pliable plastic sheet into a desired shape. An embodiment of a thermoforming sequence is described; however, this should not be construed as limiting thermoforming methods useful with the thermoplastic polyurethanes of this disclosure. First, an extrudate film of the thermoplastic polyurethane (and any other layers or materials) is placed on a shuttle rack to hold it during heating. The shuttle rack indexes into the oven which pre-heats the film before forming. Once the film is heated, the shuttle rack indexes back to the forming tool. The film is then vacuumed onto the forming tool to hold it in place and the forming tool is closed. The forming tool can be either “male” or “female” type tools. The tool stays closed to cool the film and the tool is then opened. The shaped laminate is then removed from the tool.

The present disclosure also provides an article where the article is shaped by extruding the thermoplastic polyurethane. That is, this disclosure provides for an article which is made by forcing molten thermoplastic polyurethane through a die to form a shape with a fixed cross-section.

The thermoplastic polyurethane composition of the present disclosure and any blends thereof may be formed into monolayer or multilayer films. These films may be formed by any of the conventional techniques known in the art including extrusion, co-extrusion, extrusion coating, lamination, blowing and casting or any combination thereof. The film may be obtained by the flat film or tubular process which may be followed by orientation in a uniaxial direction or in two mutually perpendicular directions in the plane of the film. One or more of the layers of the film may be oriented in the transverse and/or longitudinal directions to the same or different extents. This orientation may occur before or after the individual layers are brought together. Typically, the films are oriented in the Machine Direction (MD) at a ratio of up to 15, preferably between 5 and 7, and in the Transverse Direction (TD) at a ratio of up to 15 preferably 7 to 9. However, in another embodiment, the film is oriented to the same extent in both the MD and TD directions.

In another embodiment, the layer comprising the thermoplastic composition of this disclosure or any blends thereof may be combined with one or more other layers. The other layer(s) may be any layer typically included in multilayer film structures. For example, the other layer or layers may be: (i) polyolefins including homopolymers or copolymers of C₂ to C₄₀ olefins, preferably C₂ to C₂₀ olefins, preferably a copolymer of an α-olefin and another olefin or an α-olefin (ethylene is defined to be an α-olefin for purposes of this disclosure). Suitable polyolefins also include homopolyethylene, homopolypropylene, propylene copolymerized with ethylene and or butene, ethylene copolymerized with one or more of propylene, butene or hexene, and optional dienes. Suitable examples include thermoplastic polymers such as ultra-low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics; (ii) polar polymers including homopolymers and copolymers of esters, amides, acetates, anhydrides, copolymers of a C₂ to C₂₀ olefin, such as ethylene and/or propylene and/or butene with one or more polar monomers such as acetates, anhydrides, esters, alcohol, and or acrylics. Preferred examples include polyesters, polyamides, ethylene vinyl acetate copolymers, and polyvinyl chloride; (iii) cationic polymers including polymers or copolymers of geminally disubstituted olefins, α-heteroatom olefins and/or styrenic monomers. Preferred geminally disubstituted olefins include isobutylene, isopentane, isoheptane, isohexane, isooctene, isodecane, and isododecane. Suitable α-heteroatom olefins include vinyl ether and vinyl carbazole, preferred styrenic monomers include styrene, alkyl styrene, para-alkyl styrene, a-methyl styrene, chloro-styrene, and bromo-para-methyl styrene. Suitable examples of cationic polymers include butyl rubber, isobutylene copolymerized with para methyl styrene, polystyrene, and poly-a-methyl styrene; (iv) other suitable layers which may be paper, wood, cardboard, metal, metal foils (such as aluminum foil and tin foil), metallized surfaces, glass (including silicon oxide (SiOx) coatings applied by evaporating silicon oxide onto a film surface), fabric, spunbonded fibers, and nonwovens (particularly polypropylene spun bonded fibers or nonwovens), and substrates coated with inks, dyes, and pigments.

Films made from thermoplastic polyurethanes of the present disclosure may vary in thickness depending on the intended application, however films of a thickness from 1 to 250 microns may be suitable. Films intended for packaging may be from 10 to 60 microns thick. The thickness of the sealing layer is typically 0.2 to 50 microns. There may be a sealing layer on both the inner and outer surfaces of the film or the sealing layer may be present on only the inner or the outer surface.

The present disclosure also provides an extruded sheet formed from the thermoplastic polyurethane of the present disclosure. In one embodiment, the sheet has a thickness from 10 mils to 1,000 mils, for example from 15 mils to 500 mils, and further for example from 20 mils to 100 mils.

In one embodiment, films made from the thermoplastic polyurethane of the present disclosure are used for surface protection. In one embodiment, there is provided a surface protection film comprising a thermoplastic polyurethane obtained from the reaction of a reaction mixture comprising: (i) a polyisocyanate comprising isophorone diisocyanate, (ii) a polyol component comprising an aliphatic polyester polyol or an aliphatic polyether polyol and (iii) a chain extender.

In another embodiment, films made from the thermoplastic polyurethane of the present disclosure are used for producing a glazing or glass-containing laminate. Thus, there is provided a laminate comprising a first pane comprising a glass-glass laminate structure; a second pane; and an interlayer disposed between the first pane and the second pane and comprising the thermoplastic polyurethane of the present disclosure.

The first pane and the second pane are laminated to each other with the interlayer. At least the first pane comprises a glass-glass laminate structure. The glass-glass laminate structure comprises at least a first glass layer and a second glass layer adjacent to the first glass layer. For example, the first glass layer comprises a core layer, and the second glass layer comprises a cladding layer adjacent to the core layer. In some embodiments, the cladding layer comprises a first cladding layer and a second cladding layer, and the core layer is disposed between the first cladding layer and the second cladding layer. Each of the first glass layer and the second glass layer comprises a glass material, a glass-ceramic material, or a combination thereof. In some embodiments, the first glass layer and/or the second glass layer are transparent glass layers. In some embodiments, the cladding layer has a different CTE than the core layer. Such a CTE mismatch between the cladding layer and the core layer can enable a strengthened glass-glass laminate structure with significant damage tolerance. The second pane comprises a glass sheet (e.g., a strengthened or non-strengthened glass sheet), a polar polymer sheet (i.e., including a sheet of any polar polymer described herein), or another suitable sheet material, or combinations thereof. In some embodiments, the second pane comprises a second glass-glass laminate structure that can be the same as or different than the glass-glass laminate structure of the first pane.

Thus, in another embodiment there is provided an article comprising a thermoplastic polyurethane, where the thermoplastic polyurethane is obtained from the reaction of a reaction mixture comprising: (i) a polyisocyanate comprising isophorone diisocyanate, (ii) a polyol component comprising an aliphatic polyester polyol or an aliphatic polyether polyol, and (iii) a chain extender. In one embodiment, the article is a film or coating for protecting a surface or an interlayer of a glazing. In another embodiment, the article is an interior or exterior automotive part, or an electronic device or a consumer product.

In another embodiment, the thermoplastic polyurethane of the present disclosure or any blends thereof may be used to prepare molded products in any molding process. Such molding processes are well known to those of ordinary skill in the art and include but are not limited to, cast molding, cold forming matched-die molding, compression molding, foam molding, injection molding, gas-assisted injection molding, rotational molding, slush molding, transfer molding, vacuum forming, wet lay-up or contact molding, blow molding, extrusion blow molding, injection blow molding, and injection stretch blow molding or combinations thereof.

In one embodiment, the thermoplastic polyurethane may be adhered to or over another polymeric part, in a process known as over-molding to form the article. The over-molding process comprises the following: (a) a substrate formed from a composition comprising a polar polymer, and (b) a molded overlay formed from an inventive thermoplastic polyurethane. In one embodiment, the polar polymer is a polycarbonate (PC), ABS, PC/ABS, PBT/ABS, nylon, or another thermoplastic polyurethane. This disclosure also provides an over-molded article comprising the following: (a) a substrate formed from an inventive thermoplastic polyurethane, and (b) a molded overlay formed from a composition comprising a polar polymer.

In yet another embodiment, the thermoplastic polyurethane may be secured to a substrate material using a blow molding operation to form the article. Blow molding is particularly useful in such applications as for making closed articles such as fuel tanks and other fluid containers, playground equipment, outdoor furniture, and small enclosed structures. In one embodiment of this process, the thermoplastic polyurethane is extruded through a multi-layer head, followed by placement of the uncooled laminate into a parison in the mold. The mold, with either male or female patterns inside, is then closed and air is blown into the mold to form the part.

In another embodiment, articles may be made by injection molding processes. In injection molding, a shaped laminate is placed into the injection molding tool. The mold is closed and the substrate material is injected into the mold. The substrate material has a melt temperature between 200°−300° C. in one embodiment and from 215°−250° C. in another embodiment is injected into the mold at an injection speed of between 2 and 10 seconds. After injection, the material is packed or held at a predetermined time and pressure to make the part dimensionally and aesthetically correct. Typical time periods are from 5 to 25 seconds and pressures from 1,380 to 10,400 kPa. The mold is cooled between 10°−70° C. to cool the substrate. The temperature will depend on the desired gloss and appearance desired. Typical cooling time is from 10 to 30 seconds, depending on part on the thickness. Finally, the mold is opened and the shaped composite article ejected.

The following examples are provided to illustrate the present disclosure but are not intended to limit the scope thereof.

### EXAMPLES

### TPU Synthesis

Thermoplastic polyurethanes (TPU) were synthesized through a one-shot process by reacting an aliphatic diisocyanate (H₁₂-MDI or isophorone diisocyanate), a polyol component, a chain extender, and conventional additives (e.g., antioxidant, UV stabilizer) in a reaction vessel. The reaction mixture was heated to 90° C., then poured into a Teflon lined mold and set in an oven at 140° C. for two hours. The TPU was then granulated and extruded into films using a single screw extruder for physical property measurements.

The tensile and tear properties of the films were determined on an Instron machine according to ASTM D412 and D624, respectively. Melting temperature was measured on a Mettler-Toledo Thermal Mechanical Analyzer (TMA) with a 10° C./min ramp rate. Glass transition temperature (Tg) was taken from peak maximum on the loss modulus curve measured with a Q800 dynamic mechanical analyzer (DMA) from TA Instruments in tension mode. Yellowness Index of the film was measured according to ASTM E313 with a BYK colorimeter. Haze and light transmission of the film were measured according to ASTM D1003 using a Haze-gard Plus machine from BYK.

Table 1 shows the properties of a TPUs prepared from a polyol component containing a polycaprolactone (PCL) polyol having different molecular weights and a polyisocyanate containing isophorone diisocyanate (IPDI) or H₁₂-MDI. The TPU of Example 1 has comparable tensile strength and elongation at break, tear strength, and melting temperature with a higher glass transition temperature (Tg) as that for the TPU of Comparative Example 1. The TPU of Example 2, which employed a higher molecular weight PCL polyol, exhibited a more comparable Tg to that for the TPU of Comparative Example 1. Color, haze, and light transmission of the TPUs of Examples 1 and 2 were all acceptable, indicating that TPU's made from IPDI can exhibit similar low yellowing and high transparency characteristics as those for TPU's made from H₁₂-MDI.

TABLE 1
Physical property comparison of PCL
based TPU made from H₁₂-MDI and IPDI

| | | | |
|---|---|---|---|
| Sample | Comp. Ex. 1 | Ex. 1 | Ex. 2 |

Formulation

| | | | |
|---|---|---|---|
| Isocyanate | H₁₂-MDI | IPDI | IPDI |
| PCL Polyol MW | 1250 | 1250 | 2000 |

Film Physical Properties

| | | | |
|---|---|---|---|
| Tensile Strength (MPa) | 66.7 | 73.9 | 78.1 |
| Elongation at Break (%) | 385 | 370 | 400 |
| Tear Strength (N/mm) | 107 | 100 | 82 |
| TMA Peak (° C.) | 122 | 115 | 114 |
| Tg (DMA, ° C.) | −19.1 | 0.4 | −24.5 |
| Yellowness Index | 0.2 | 0.1 | 0.1 |
| Haze (%) | 4.7 | 7.6 | 5.3 |
| Light Transmission (%) | 93.7 | 93.9 | 93.9 |

TPUs were then produced using polytetrahydrofuran (PolyTHF) as the polyol component and H₁₂-MDI or IPDI as the polyisocyanate. The TPU of Example 3 shows comparable properties to those for the TPU of Comparative Example 2 in terms of tensile strength and elongation at break, tear strength, and melting temperature but with a higher Tg (although still well below typical use temperatures for TPU) as those for the TPU of Comparative Example 2. Moreover, the polyTHF and IPDI based TPU exhibited low yellowing and high transparency properties similar to those for the TPU of Comparative Example 2.

TABLE 2
Physical property comparison of PolyTHF
based TPU made from H₁₂-MDI and IPDI.

| | | |
|---|---|---|
| Sample | Comp. Ex. 2 | Ex. 3 |

Formulation

| | | |
|---|---|---|
| Iso | H₁₂-MDI | IPDI |
| PolyTHF Polyol MW | 1000 | 1000 |

Film Physical Properties

| | | |
|---|---|---|
| Tensile Strength (MPa) | 55.0 | 66.2 |
| Elongation at Break (%) | 410 | 440 |
| Tear Strength (N/mm) | 46 | 54 |
| TMA Peak (° C.) | 133 | 133 |
| Tg (DMA, ° C.) | −59.3 | −48.7 |
| Yellowness Index | 1.3 | 0.8 |
| Haze (%) | 4 | 3.6 |
| Light Transmission (%) | 93.5 | 93.8 |

Overall, the results above demonstrated that TPU films can be successfully produced using IPDI in place of H₁₂-MDI. In particular, such films can exhibit at least comparable, if not better, performance properties as compared to those for TPU films produced using H₁₂-MDI.

While the foregoing is directed to embodiments of the present disclosure, other and further embodiments of the disclosure may be devised without departing from the basic scope thereof, and the scope thereof is determined by the claims that follow.

1. A thermoplastic polyurethane obtained from the reaction of a reaction mixture comprising:
(i) a polyisocyanate comprising an isophorone diisocyanate, (ii) a polyol component comprising an aliphatic polyester polyol or an aliphatic polyether polyol, and (iii) a chain extender.

2. The thermoplastic polyurethane of claim 1, wherein the aliphatic polyester polyol is obtained from the reaction of one or more aliphatic carboxylic acids and one or more polyols.

3. The thermoplastic polyurethane of claim 1, wherein the aliphatic polyester polyol is a polylactone polyol.

4. The thermoplastic polyurethane of claim 3, wherein the polylactone polyol is a polycaprolactone polyol.

5. The thermoplastic polyurethane of claim 4, wherein the polycaprolactone polyol has an average molecular weight of or from about 1000 Da to about 3000 Da.

6. The thermoplastic polyurethane of claim 1, wherein the aliphatic polyether polyol is a polytetrahydrofuran polyol having a general structure: 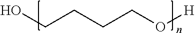
where n is an integer of from about 1 to about 100,

7. The thermoplastic polyurethane of claim 6, wherein the polytetrahydrofuran polyol has a weight average molecular weight of from about 1000 Da to about 2750 Da.

8. The thermoplastic polyurethane of claim 1, wherein the chain extender comprises a diol, a triol or a mixture thereof.

9. The thermoplastic polyurethane of claim 1, wherein the chain extender comprises an aliphatic glycol having 2 to 12 carbon atoms.

10. The thermoplastic polyurethane of claim 1, further comprising one or more additives.

11. An article obtained by injection molding the thermoplastic polyurethane of claim 1.

12. An article obtained by extruding the thermoplastic polyurethane of claim 1.

13. A surface protection film comprising the thermoplastic polyurethane of claim 1.

14. A laminate comprising a first pane comprising a glass-glass laminate structure, a second pane, and an interlayer disposed between the first pane and the second pane and comprising the thermoplastic polyurethane of claim 1.

15. The laminate of claim 14, wherein the second pane comprises a glass sheet or a polar polymer sheet.

16. An article comprising a thermoplastic polyurethane obtained from the reaction of a reaction mixture comprising: (i) a polyisocyanate comprising an isophorone diisocyanate, (ii) a polyol component comprising an aliphatic polyester polyol or an aliphatic polyether polyol, and (iii) a chain extender and wherein the thermoplastic polyurethane has one or more of the following properties: an ASTM D-1003 haze value of less than about 10%; an ASTM E313 yellowness index of less than 1%; an elongation at break of at least about 365% according to ASTM D412; and a tensile strength of at least about 65 MPa according to ASTM D412.

17. The article of claim 16, wherein the polyol component consists essentially of an aliphatic polyester polyol.

18. The article of claim 17, wherein the aliphatic polyester polyol is a polycaprolactone polyol.

19. The article of claim 16, wherein the polyol component consists essentially of a polyether polyol.

20. The article of claim 19, wherein the polyether polyol is a polytetrahydrofuran polyol.

21. The article of claim 16, wherein the article is an interior automotive part or an exterior automotive part or an electronic device.

22. The article of claim 16, wherein the article comprises a surface protection film or a glass-containing laminate.
